(19) United States
(12) Patent Application Publication
(10) Pub. No.: US 2020/0092688 A1
(43) Pub. Date: Mar. 19, 2020

(54) CALL ROUTING WITH A MOBILE NETWORK OPERATOR SUPPORTING A MOBILE VIRTUAL NETWORK OPERATOR

(71) Applicant: FIRST ORION CORP., Little Rock, AR (US)

(72) Inventors: Robert Francis Piscopo, JR., Kirkland, WA (US); Julie Sara Fowler, Kirkland, WA (US); Michael Joseph Furey, Lithia, FL (US); Charles D. Morgan, Little Rock, AR (US)

(21) Appl. No.: 16/575,856

(22) Filed: Sep. 19, 2019

Related U.S. Application Data
(60) Provisional application No. 62/733,356, filed on Sep. 19, 2018.

(51) Int. Cl. H04W 4/16; H04W 8/28; H04L 29/06

(52) U.S. Cl. CPC H04W 4/16; H04L 65/1016; H04L 65/1006; H04W 8/28

(57) ABSTRACT

One example method of operation may include identifying a call destined for a mobile device, querying a number portability database for call routing information, receiving one or more of a location routing number assigned to the mobile network operator and a location routing number assigned to the mobile virtual network operator, forwarding a call message associated with the call to a session border control device operated by the mobile network operator, and determining whether to route the call to a mobile network operator subscriber or a mobile virtual network operator based on whether the location routing number is assigned to the mobile network operator or the mobile virtual network operator.

### CROSS-REFERENCE TO RELATED APPLICATIONS

This application claims priority to earlier filed U.S. provisional patent application No. 62/733,356, entitled “Cloud Based Call Protection”, filed on Sep. 19, 2018, the entire contents of which are hereby incorporated by reference.

### TECHNICAL FIELD OF THE APPLICATION

This application relates to call routing in a carrier network, and more specifically to providing call routing services on a mobile network operator that supports a mobile virtual network operator.

### BACKGROUND OF THE APPLICATION

Conventionally, mobile device which are subscribed to a particular mobile network operator (carrier) network, may receive calls based on a legacy routing process. When virtual mobile network operator (MVNO) subscribers, which are subscribed through a particular MNO host to receive calls, the amount of information processing and routing procedures may increase substantially. MVNO routing execution requires its sponsor network (MNO) to incorporate and deploy MVNO-specific solutions within their networks. While the value and feasibility of the new service may make a requesting MVNO a viable service, such a routing configuration plan often requires additional infrastructure investment and significant efforts to support such MVNO services.

Other conventional measures for managing such services require creation of new interconnection agreements, and significant efforts to distinguish, provision and maintain new commercial and/or technical instances to differentiate the MVNO from the MNO.

### SUMMARY OF THE APPLICATION

Example embodiments of the present application provide a method including one or more of identifying a call destined for a mobile device, querying a number portability database for call routing information, receiving one or more of a location routing number assigned to the mobile network operator and a location routing number assigned to the mobile virtual network operator, forwarding a call message associated with the call to a session border control device operated by the mobile network operator, and determining whether to route the call to a mobile network operator subscriber or a mobile virtual network operator based on whether the location routing number is assigned to the mobile network operator or the mobile virtual network operator.

Another example embodiment of the present application includes an apparatus that includes a processor configured to identify a call destined for a mobile device, query a number portability database for call routing information, a receiver configured to receive one or more of a location routing number assigned to the mobile network operator and a location routing number assigned to the mobile virtual network operator, and the processor is further configured to forward a call message associated with the call to a session border control device operated by the mobile network operator, and determine whether to route the call to a mobile network operator subscriber or a mobile virtual network operator based on whether the location routing number is assigned to the mobile network operator or the mobile virtual network operator.

Still another example embodiment may include a non-transitory computer readable storage medium configured to store instructions that when executed cause a processor to perform one or more of identifying a call destined for a mobile device, querying a number portability database for call routing information, receiving one or more of a location routing number assigned to the mobile network operator and a location routing number assigned to the mobile virtual network operator, forwarding a call message associated with the call to a session border control device operated by the mobile network operator, and determining whether to route the call to a mobile network operator subscriber or a mobile virtual network operator based on whether the location routing number is assigned to the mobile network operator or the mobile virtual network operator.

### BRIEF DESCRIPTION OF THE DRAWINGS

FIG. 1 illustrates an example mobile network operator call management network sponsoring a mobile virtual network operator according to example embodiments.

FIG. 2 illustrates an example mobile network operator call management network sponsoring a mobile virtual network operator according to example embodiments.

FIG. 3 illustrates a system configuration of a mobile virtual network subscriber call being routed via a sponsoring mobile network operator network.

FIG. 4 illustrates a logic flow diagram for managing a call routing procedure for a subscriber according to example embodiments.

FIG. 5 illustrates a logic processing configuration for processing data associated with call routing procedures according to example embodiments.

FIG. 6 illustrates an example network entity device configured to store instructions, software, and corresponding hardware for executing the same, according to example embodiments of the present application.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

Example embodiments provide a procedure that delivers cloud-based call protection services to a mobile virtual network operator (MVNO) via a sponsoring mobile network operator (MNO) configured to provide a carrier network service for the MVNO. This approach provides the ability to differentiate incoming calls as destined for mobile devices which are subscribed to the MVO or MVNO internally and reduces the time and management operations it takes to route calls destined for a MVNO subscriber mobile device.

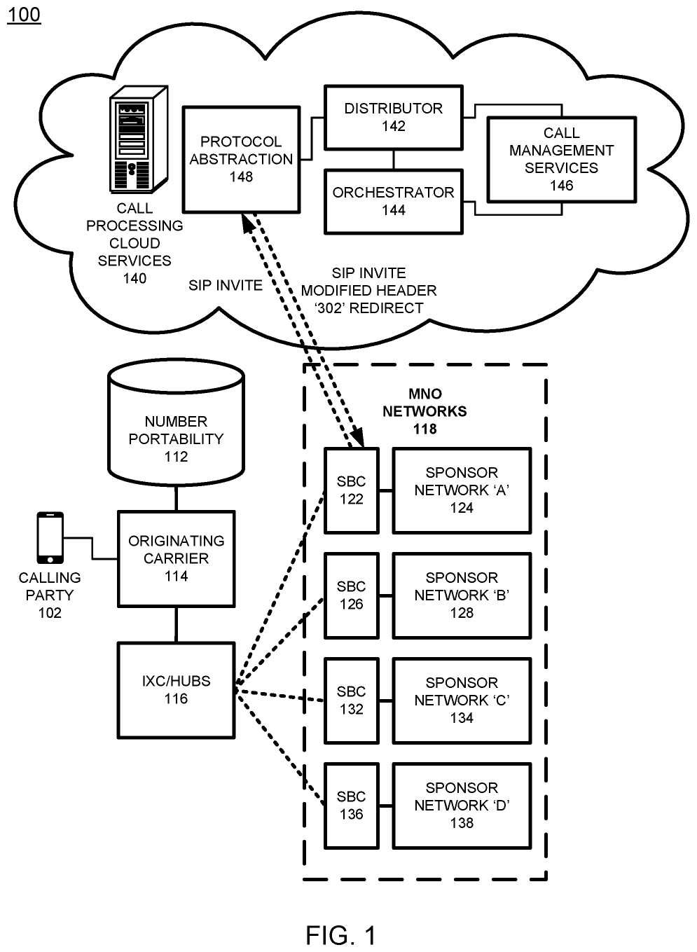

FIG. 1 illustrates an example mobile network operator call management network sponsoring a mobile virtual network operator according to example embodiments. Referring to FIG. 1, the configuration 100 includes a calling party 102 placing a call destinated for a called party. The carrier 114 may be any carrier service provider network that is configured to route calls to subscribers. The carrier 114 must query a number portability database 112 which can provide routing information regarding the subscriber, such as location routing numbers (LRNs) used by the network and/or supported virtual networks. Once the information is received, the interexchange carrier/hubs (IXC) 116 may attempt to communicate with the session border control (SBC) devices 122-136, which are part of the MNO network 118. In this example, the MNO may sponsor various other networks 124-138 (virtual networks), which subscribe to have their calls managed by the MNO network.

According to example embodiments, the various LRNs used to identify native MNO subscribers, MVNO subscribers from various MVNO networks, etc., are internally assigned to each MVNO by each MNO acting as a sponsoring network operator. The points of interest (POIs) (i.e., routes) for the new LRNs used by the MVNOs and hosted by the MNO, such as new IP addresses on existing SBCs or new SBCs can all be identified by the LRNs, along with third party cloud network resources and out-of-network devices supporting the MVNOs.

The MNO/sponsor updates made to a local exchange routing guide (LERG) are used to reflect LRN and POI information used for call routing. The incoming call signaling (SIP INVITEs) routed by IXC/peering partners 116 to MNO native and new SBC IP addresses can be performed when the LRN information is updated for all service providers using the network. For example, the SBCs forward SIP INVITEs to a cloud delegator framework 140, which may include a protocol abstraction layer 148, a distributor 142, an orchestrator 144 and other call management services 146 provided by that particular MVNO. In one example, the SBC 122 forward a SIP INVITE when the call message indicates a particular MVNO subscriber as the intended destination. The delegator framework may modify the SIP INVITE data and submit a redirect SIP 302 message to reroute the call to its intended destination when the call is not intended for a subscriber of the MNO network but is instead a subscriber of the MVNO network.

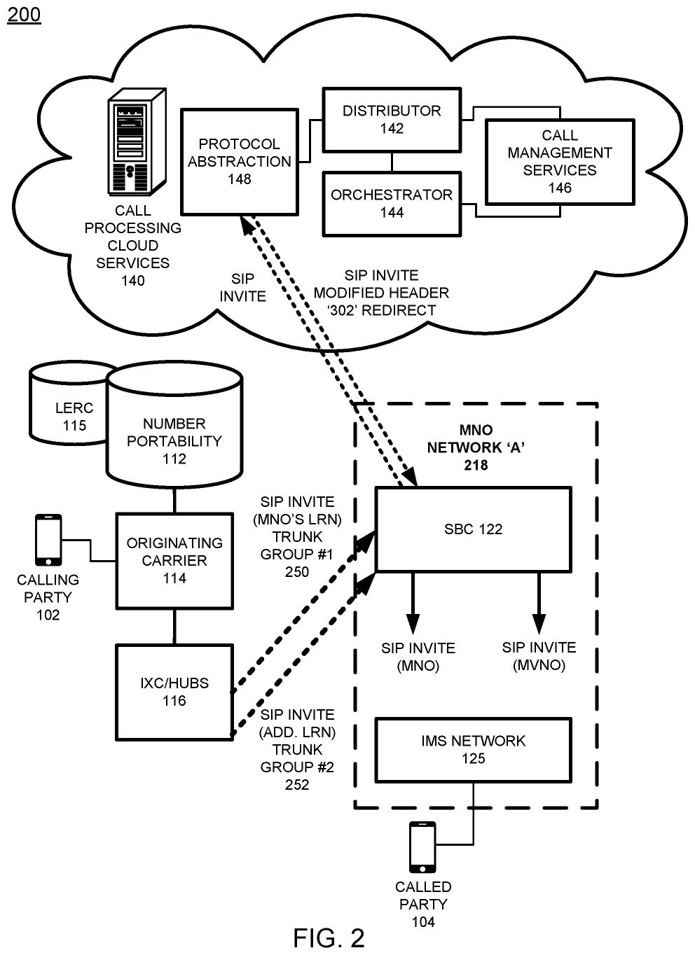

FIG. 2 illustrates an example mobile network operator call management network sponsoring a mobile virtual network operator according to example embodiments. Referring to FIG. 2, the configuration 200 provides an example where the LERC data 115 is updated to include the LRNs of both the MNO and MVNO service providers. The example provides a MNO sponsored network ‘A’ 218 receiving call routing information from one or more trunk 250/252 groups defined by local LRN MNO call routing and third party LRN MVNO call routing. When calls are destined for a MVNO subscriber, they may use a non-native trunk group defined by the LRNs for that virtual service provider instead of the native MNO trunk group.

In this example, the MNO sponsor operator assigns a location routing number (LRN) to the MVNO for use with the services of that MNO. This LRN is a ten-digit number that uniquely identifies a particular switch or point of interconnection/interest (POI) that can be used to route calls to numbers that have been ported. In the case of this example, the additional LRN, or set of additional LRNs will be leveraged to enable subscriber-level differentiation between telephone numbers belonging to the MNO itself and telephone numbers belonging to the MNO which have been assigned by the MNO to the MVNO as part of its sponsorship agreement.

In operation, the MNO assigns and provisions additional session border controller (SBC) ports, IP addresses and configurations to support the termination of traffic for the additional LRNs that are associated with the differentiated MVNO subscriber traffic. A new SIP trunk(s) 252 may be established by the MNO/sponsor operator network and each of its existing interconnect partners. The new SIP trunk(s) will be provisioned in parallel to the existing SIP trunk(s) 252 between the MNO and its interconnected parties, and will carry the traffic destined to the additional LRN(s) that have been assigned to the MVNO, once it has been differentiated during the number portability lookup operation. Overbooking parameters may be configured across the existing and new SIP trunks to provide for failover and redundancy measures in the event of failures, outages and/or network degradation.

The MNO/sponsor operator will update its existing data within the local exchange routing guide (LERG) 115, to include the additional LRN assignments and the associated POI information. This information can include but is not limited to the SBC IP addresses, transport layer port or socket numbers, signaling links, signaling point codes and other termination information that is needed to set up proper routing to the new LRN/MNO network. The end-to-end signaling flow illustrated in FIG. 2 represents a voice call which has been generated by a subscriber device (calling party 102) connected to a carrier network (originating carrier 114) toward a telephone number associated with a device 104 connected to another disparate network (i.e., MNO subscriber and MVNO subscriber). The calling party 102 that is originating the call in the example is illustrated as an end user generating a call from a mobile device, however this is not limited to human end users nor mobile devices. Calls can be originated across various user equipment (UE) types, such as fixed/wireline devices, voice over IP software clients and others. Furthermore, these calls could be generated from non-human sources including, but not limited to interactive voice platforms, automated dialers, robocall servers, etc.

Prior to routing the call attempt to the appropriate destination carrier, the originating carrier 114 must ensure that a number portability lookup is executed on the telephone number that is associated with the call attempt. This number portability lookup is handled via queries from network switching infrastructure to an authoritative number portability database 112 that provides a real-time mapping of telephone numbers to the current owning carrier name that links to the queried number, as well as additional routing information, such as a LRN that aids in determination of the proper network signaling route to the destination carrier and its connected subscriber device. The number portability database query and resolution are typically handled by the originating carrier, however, it may also be performed by the interexchange carriers (IXCs 116), network signaling hubs or other 3^{rd} party service providers that have access to the number portability corrected information.

The number portability lookup will return a result that indicates the owning carrier which belongs to the telephone number, as well as the LRN within the owning carrier that specifies the POI information where the call should be routed to next. In the case where the telephone number belongs to a subscriber of the MNO network, the LRN of the MNO will be returned. Numbers that resolve to subscribers belonging to the MVNO will return a result that indicates the owning carrier of the MNO and a separate LRN such as the additional LRN internally assigned to the MVNO by the MNO. In this example more than one LRN may be returned for routing purposes to more than one destination.

Calls are routed by the originating carrier 114 to the proper interconnection partner, IXC 116, signaling hub provider and/or direct peer, based on the LRNs that were returned as part of number portability lookup. LRN and POI routing information is maintained and updated via the LERG 115, which is widely used and updated regularly by carriers. This approach reduces the amount of administrative and technical routing updates required to enable an MVNO or multiple MVNOs by a particular MNO/sponsor operator, as the additional LRN information incorporated into the MNO's existing LERG and number portability industry data are all readily obtained by the MNO network function.

Calls that are routed to the MNO traverse the legacy SIP trunks 250 that are defined in the existing LRN to POI information currently shared via the LERG 115. Calls that are routed to the new additional LRN/MVNO traverse the new SIP trunks 252 and are designated through sharing of updated carrier LRN to POI updates, also via the LERG. There are several possible combinations of routing determination and number portability scenarios that can be performed along the intercarrier transit path, however, this approach ensures simplified routing by way of the usage of the additional LRN designator. Originating carriers that perform the number portability lookup prior to routing the call to a IXC/hub have the capability to derive the original carrier network (OCN) and LRN of the telephone number and properly route the call to the “next hop”. The IXCs and signaling hub providers can also derive and properly route to the proper MNO through use of number portability lookup and the additional LRN/POI data.

An LRN is a local/location routing number, and is used for local number portability (LNP). The local exchange routing guide (LERG) has routes and blocks of telephone numbers that are assigned to different carriers and which POIs the numbers should be routed. The POIs are physical locations where the routing devices are connected. The number portability administration center (NPAC) is a registry where LRNs can be assigned to phone numbers. If a phone number is looked-up in the NPAC before routing the call, and the phone number had an LRN assigned to it, the routing that was in place for the LRN would be used instead of the routing found in the LERG for the number that was dialed. In this example, if a 1000 block of numbers (555) 123-1xxx is in the LERG and is assigned to a major carrier, such as ‘AT&T’ and it pointed at POI ‘X’ and the block of numbers (555) 123-2xxx in the LERG is assigned to VERIZON and pointed at POI Y. As far as the LERG operates, all the numbers in the 1000 number block are pointed at their respective POIs. If VERIZON designates the number (555) 123-2999 as an LRN. This number is already pointed at POI Y. Then an AT&T subscriber with the phone number of (555) 123-1111 that wants to move to VERIZON and wants to keep their number (i.e. port their number to VERIZON). In the NPAC registry (555) 123-1111 could be assigned as an LRN of (555) 123-2999. Then when anyone calls (555) 123-1111 their carrier looks-up (555) 123-1111 in the NPAC, retrieves a LRN of (555) 123-2999 and then adds that LRN (555) 123-2999 in the signaling for the call and routes the call to where the LERG says to send traffic destined to (555) 123-2999 namely POI Y of Verizon. In this example of FIG. 2, the LRN is used as a way to route the calls to a particular POI within the same network. If VERIZON wanted to redirect MVNO traffic to this network. They could designate a new LRN (555) 123-2998 and route it to POI ‘Z’, which is a route that routes to the MNO. Then the MVNO numbers can be assigned the new LRN (555) 123-2998 and the traffic will then be routed to the cloud delegator framework.

Incoming call signaling attempts (e.g., SIP INVITEs) are received by the MNO SBC 122 and directed to the cloud platform service 140 (i.e., delegator). The original SIP INVITE is forwarded to the delegator (142-148) in its entirety by the MNO SBC 122, and then received from the cloud services 140 modified or augmented to have a new SIP INVITE message. Such a solution supports various protocols and connection methods with the MNO's SBC. The delegator cloud platform may include a protocol layer abstraction service 148 that can communicate across various types of signaling protocols and interface types, including but not limited to SIP, HTTP/REST and DNS/ENUM.

In operation, the delegator cloud platform 140 receives the incoming SIP INVITE, parses the message and distributes relevant information obtained from the incoming SIP INVITE to various worker processes in parallel via the distributor function 142. The worker processes execute their own respective services and deliver information and disposition back to the distributor 142. The distributor interfaces with the orchestrator function 144 to inspect the results from each worker process and subsequently applies the appropriate subscriber-level policy prior to sending the modified SIP INVITE back toward the carrier network. The services 146 may be any one or more services which are used to further process calls received. The delegator platform delivers a modified SIP INVITE message back to the MNO SBC so that proper disposition of the incoming call can be carried out on behalf of the MVNO and its associated subscriber. The MNO SBC 122 receives the incoming modified SIP INVITE header and inspects the SIP header information for attributes regarding disposition status or handling instructions. Once the call destination is determined, the IMS network 125 may be used to reach the calling party 104. The SIP INVITE sent to the called device 104 may be from a MNO direct source or a MVNO source depending on the subscriber's relationship with the MNO network.

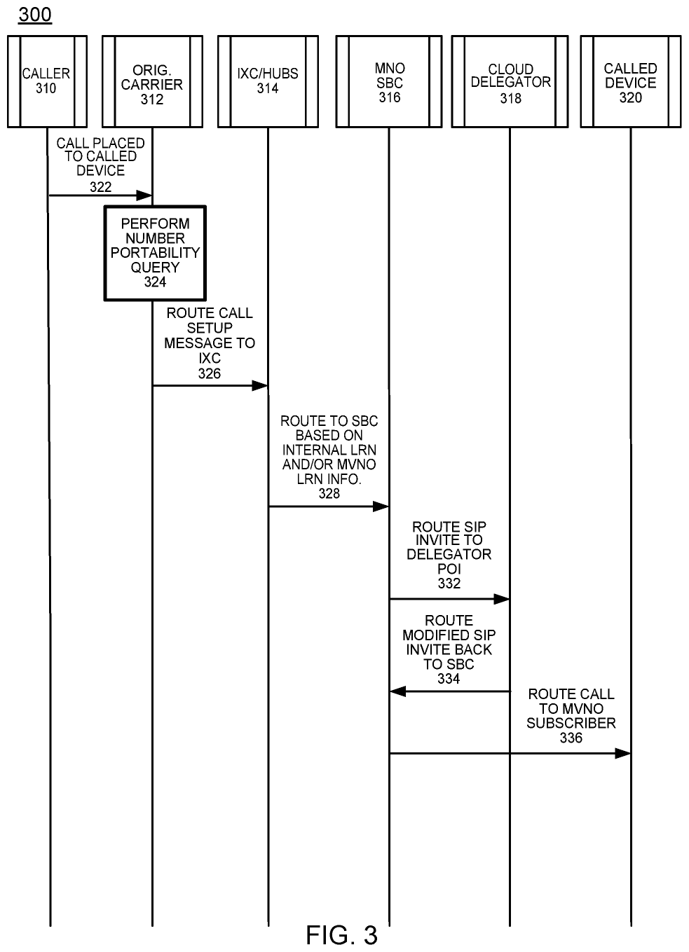

FIG. 3 illustrates a system configuration of a mobile virtual network subscriber call being routed via a sponsoring mobile network operator network. Referring to FIG. 3, the configuration 300 provides an example of a caller 310 calling a called device 320 subscriber of a MVNO service provider. In this example, the call is placed 322 to the originating carrier 312 which performs a number portability query 324 and identifies call routing information based on the called device telephone number. The call is the routed to a IXC 314 via a call setup message 326. The IXC 314 routes the call setup 328 to the SBC 316 based on LRN information for the subscriber and the MNO network supporting the subscriber and the MVNO. The calls may be routed via different trunk groups depending on the LRN information. When the LRN information points to a POI of the MVO, the cloud delegator 318 may receive 332 the call message INVITE. The delegator 318 may modify the message and send the SIP INVITE modified back 334 to the SBC 316 which forwards the call 336 to the called device. For example, with regard to modifying the SIP INVITE header, in most cases the display name parameter would be changed in the P-asserted-identity header and the from header. In some cases, a ‘Verstat’ parameter would be included in the ‘P-Asserted-Identity’ header and the ‘from’ header.

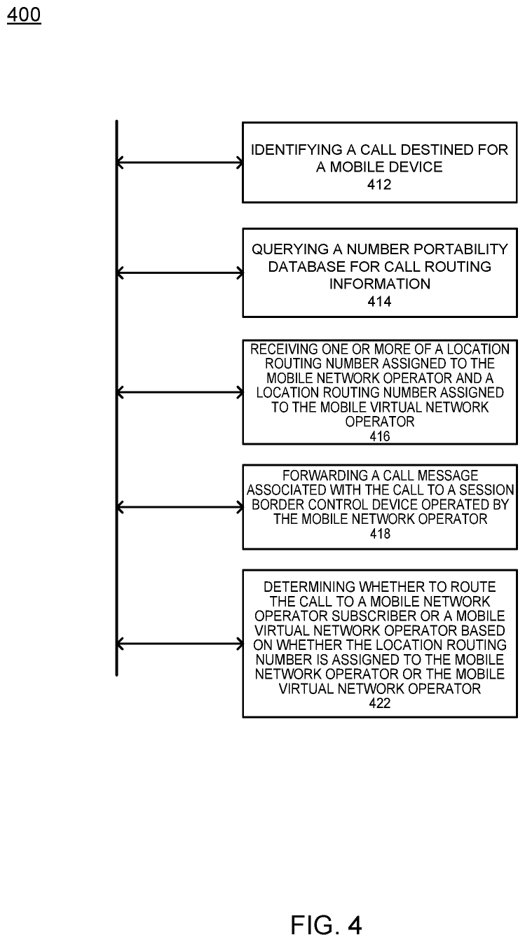

FIG. 4 illustrates a logic flow diagram for managing a call routing procedure for a subscriber according to example embodiments. Referring to FIG. 4, the process 400 may include identifying a call destined for a mobile device 412, querying a number portability database for call routing information 414, receiving one or more of a location routing number assigned to the mobile network operator and a location routing number assigned to the mobile virtual network operator 416. The process may also include forwarding a call message associated with the call to a session border control device operated by the mobile network operator 418, and determining whether to route the call to a mobile network operator subscriber or a mobile virtual network operator based on whether the location routing number is assigned to the mobile network operator or the mobile virtual network operator 422.

Continuing with the same example, when the mobile device is subscribed to the mobile virtual network operator, the process may include redirecting the call message to a point of interconnection/interest device configured to manage calls to mobile devices subscribed to the mobile virtual network operator, receiving the call message at the session border control device with a modified header, once the device modifies the call message, and forwarding the modified call message to the mobile device based on the modified header. In this example, the mobile virtual network operator is managed by the network mobile network operator and the location routing number assigned to the mobile virtual network operator includes a point of interface outside of a mobile network operator network, such as in the cloud or a third party network. In another alternative, when the mobile device is subscribed to the mobile network operator, the process provides forwarding a SIP INVITE message including the mobile network operator location routing number to the session border control via a first trunk group. When the mobile device is subscribed to the mobile virtual network operator, the process provides forwarding a SIP INVITE message including the mobile virtual network operator location routing number to the session border control device via a second trunk group different from a first trunk group used to route calls to mobile devices subscribed to the mobile network operator. The point of interface/interconnection device may be located in a cloud network outside a mobile network operator network.

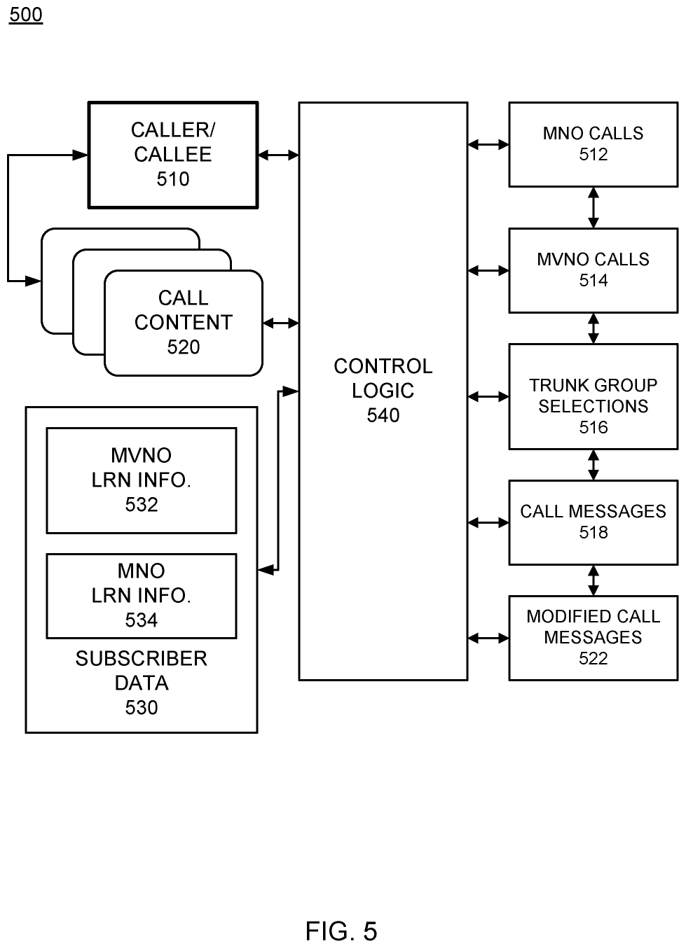

FIG. 5 illustrates a logic processing configuration for processing data associated with call routing procedures according to example embodiments. Referring to FIG. 5, the configuration 500 includes a caller/callee designation identified in an incoming call 510 along with other call content data 520. The subscriber data 530 may include LRN information from the MNO and/or the MVNO depending on the destination of the call routing. The control logic 540 may process the data to output a MNO call 512, MVNO call 514, a trunk group selection 516, call messages 518 and a modified call messages 522 for routing the call to the correct destination when the call is intended for a MVNO subscriber.

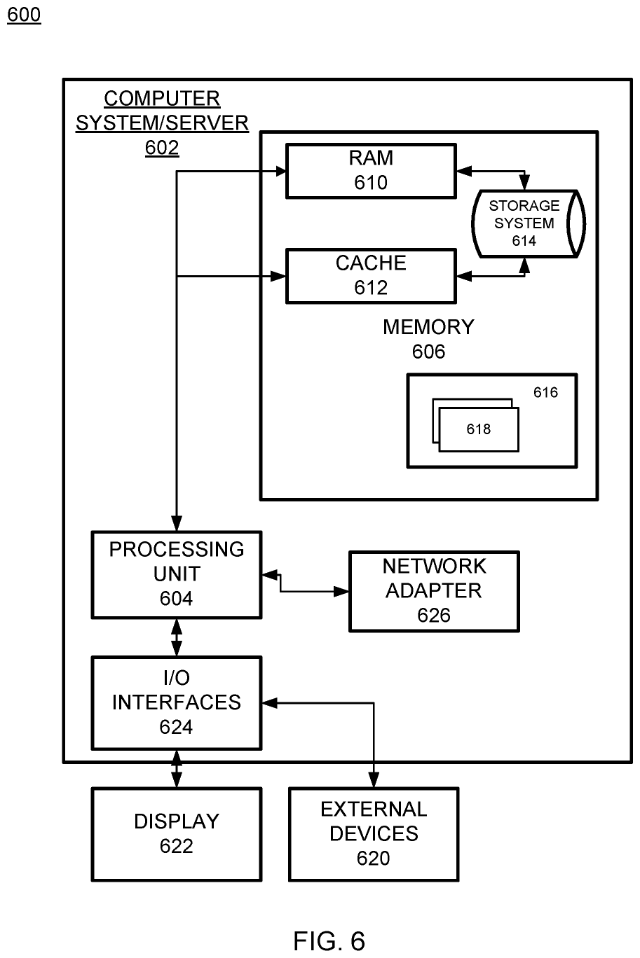

FIG. 6 illustrates an example network entity device configured to store instructions, software, and corresponding hardware for executing the same, according to example embodiments of the present application.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

FIG. 6 is not intended to suggest any limitation as to the scope of use or functionality of embodiments of the application described herein. Regardless, the computing node 600 is capable of being implemented and/or performing any of the functionality set forth hereinabove.

In computing node 600 there is a computer system/server 602, which is operational with numerous other general purpose or special purpose computing system environments or configurations. Examples of well-known computing systems, environments, and/or configurations that may be suitable for use with computer system/server 602 include, but are not limited to, personal computer systems, server computer systems, thin clients, rich clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 602 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 602 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 602 in cloud computing node 600 is shown in the form of a general-purpose computing device. The components of computer system/server 602 may include, but are not limited to, one or more processors or processing units 604, a system memory 606, and a bus that couples various system components including system memory 606 to processor 604.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 602 typically includes a variety of computer system readable media. Such media may be any available media that is accessible by computer system/server 602, and it includes both volatile and non-volatile media, removable and non-removable media. System memory 606, in one embodiment, implements the flow diagrams of the other figures. The system memory 606 can include computer system readable media in the form of volatile memory, such as random-access memory (RAM) 610 and/or cache memory 612. Computer system/server 602 may further include other removable/non-removable, volatile/non-volatile computer system storage media. By way of example only, storage system 614 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 606 may include at least one program product having a set (e.g., at least one) of program modules that are configured to carry out the functions of various embodiments of the application.

Program/utility 616, having a set (at least one) of program modules 618, may be stored in memory 606 by way of example, and not limitation, as well as an operating system, one or more application programs, other program modules, and program data. Each of the operating system, one or more application programs, other program modules, and program data or some combination thereof, may include an implementation of a networking environment. Program modules 618 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 602 may also communicate with one or more external devices 620 such as a keyboard, a pointing device, a display 622, etc.; one or more devices that enable a user to interact with computer system/server 602; and/or any devices (e.g., network card, modem, etc.) that enable computer system/server 602 to communicate with one or more other computing devices. Such communication can occur via I/O interfaces 624. Still yet, computer system/server 602 can communicate with one or more networks such as a local area network (LAN), a general wide area network (WAN), and/or a public network (e.g., the Internet) via network adapter 626. As depicted, network adapter 626 communicates with the other components of computer system/server 602 via a bus. It should be understood that although not shown, other hardware and/or software components could be used in conjunction with computer system/server 602. Examples include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
identifying a call destined for a mobile device;
querying a number portability database for call routing information;
receiving one or more of a location routing number assigned to the mobile network operator and a location routing number assigned to the mobile virtual network operator;
forwarding a call message associated with the call to a session border control device operated by the mobile network operator; and
determining whether to route the call to a mobile network operator subscriber or a mobile virtual network operator based on whether the location routing number is assigned to the mobile network operator or the mobile virtual network operator.

2. The method of claim 1, comprising:
when the mobile device is subscribed to the mobile virtual network operator:
redirecting the call message to a point of interface device configured to manage calls to mobile devices subscribed to the mobile virtual network operator;
receiving the call message at the session border control device with a modified header; and
forwarding the call message to the mobile device based on the modified header.

3. The method of claim 1, wherein the mobile virtual network operator is managed by the mobile network operator.

4. The method of claim 1, wherein the location routing number assigned to the mobile virtual network operator comprises a point of interface outside of a mobile network operator network.

5. The method of claim 1, comprising:
when the mobile device is subscribed to the mobile network operator, forwarding a SIP INVITE message comprising the mobile network operator location routing number to the session border control via a first trunk group.

6. The method of claim 1, comprising:
when the mobile device is subscribed to the mobile virtual network operator, forwarding a SIP INVITE message comprising the mobile virtual network operator location routing number to the session border control device via a second trunk group different from a first trunk group used to route calls to mobile devices subscribed to the mobile network operator.

7. The method of claim 1, wherein the point of interface device is located in a cloud network outside a mobile network operator network.

8. An apparatus comprising:
a processor configured to
identify a call destined for a mobile device;
query a number portability database for call routing information;
a receiver configured to receive one or more of a location routing number assigned to the mobile network operator and a location routing number assigned to the mobile virtual network operator;
wherein the processor is further configured to
forward a call message associated with the call to a session border control device operated by the mobile network operator; and
determine whether to route the call to a mobile network operator subscriber or a mobile virtual network operator based on whether the location routing number is assigned to the mobile network operator or the mobile virtual network operator.

9. The apparatus of claim 8, wherein when the mobile device is subscribed to the mobile virtual network operator the processor is further configured to
redirect the call message to a point of interface device configured to manage calls to mobile devices subscribed to the mobile virtual network operator;
receive the call message at the session border control device with a modified header; and
forward the call message to the mobile device based on the modified header.

10. The apparatus of claim 8, wherein the mobile virtual network operator is managed by the mobile network operator.

11. The apparatus of claim 8, wherein the location routing number assigned to the mobile virtual network operator comprises a point of interface outside of a mobile network operator network.

12. The apparatus of claim 8, wherein when the mobile device is subscribed to the mobile network operator, the processor is further configured to forward a SIP INVITE message comprising the mobile network operator location routing number to the session border control via a first trunk group.

13. The apparatus of claim 8, wherein when the mobile device is subscribed to the mobile virtual network operator, the processor is configured to forward a SIP INVITE message comprising the mobile virtual network operator location routing number to the session border control device via a second trunk group different from a first trunk group used to route calls to mobile devices subscribed to the mobile network operator.

14. The apparatus of claim 8, wherein the point of interface device is located in a cloud network outside a mobile network operator network.

15. A non-transitory computer readable storage medium configured to store instructions that when executed cause a processor to perform:
identifying a call destined for a mobile device;
querying a number portability database for call routing information;
receiving one or more of a location routing number assigned to the mobile network operator and a location routing number assigned to the mobile virtual network operator;
forwarding a call message associated with the call to a session border control device operated by the mobile network operator; and
determining whether to route the call to a mobile network operator subscriber or a mobile virtual network operator based on whether the location routing number is assigned to the mobile network operator or the mobile virtual network operator.

16. The non-transitory computer readable storage medium of claim 15, wherein the processor is further configured to perform, when the mobile device is subscribed to the mobile virtual network operator:
redirecting the call message to a point of interface device configured to manage calls to mobile devices subscribed to the mobile virtual network operator;
receiving the call message at the session border control device with a modified header; and
forwarding the call message to the mobile device based on the modified header.

17. The non-transitory computer readable storage medium of claim 15, wherein the mobile virtual network operator is managed by the mobile network operator.

18. The non-transitory computer readable storage medium of claim 15, wherein the location routing number assigned to the mobile virtual network operator comprises a point of interface outside of a mobile network operator network.

19. The non-transitory computer readable storage medium of claim 15, wherein the processor is further configured to perform:
when the mobile device is subscribed to the mobile network operator, forwarding a SIP INVITE message comprising the mobile network operator location routing number to the session border control via a first trunk group.

20. The non-transitory computer readable storage medium of claim 15, wherein the processor is further configured to perform:
when the mobile device is subscribed to the mobile virtual network operator, forwarding a SIP INVITE message comprising the mobile virtual network operator location routing number to the session border control device via a second trunk group different from a first trunk group used to route calls to mobile devices subscribed to the mobile network operator.
